(19) United States
(12) Patent Application Publication
(10) Pub. No.: US 2009/0142525 A1
(43) Pub. Date: Jun. 4, 2009

(54) BARRIER LAYER

(75) Inventors: Naima Boutroy, Octeville-Sur-Mer (FR); Yann Pernel, Octeville-Sur-Mer (FR)

Correspondence Address: SUGHRUE MION, PLLC, 2100 PENNSYLVANIA AVENUE, N.W., SUITE 800, WASHINGTON, DC, 20037, US

(73) Assignee: SIDEL PARTICIPATIONS, Octeville Sur Mer (FR)

(21) Appl. No.: 12/065,573

(22) PCT Filed: Sep. 9, 2005
(86) PCT No.: PCT/IB05/04087

§ 371 Date: Aug. 6, 2008

(51) Int. Cl. B32B 27/16; C08F 2/46

(52) U.S. Cl. 428/35.7; 427/508

(57) ABSTRACT

A plastic container coated with a barrier layer on an inner surface thereof and a process for coating an inner surface of a plastic container with a barrier layer. The barrier layer may contain carbon and hydrogen. The barrier layer may have a hydrogen concentration ([H]/([C]+[H])) of from about 37% to about 45%. The barrier layer may have a sp²/sp³ carbon ratio of from about 0.2 to about 0.3. The barrier layer may have an optical gap E₀₄ of from about 2.3 eV to about 2.9 eV. The barrier layer may have a spin density of from about 6×10¹⁸ cm⁻³ to about 2×10²⁰ cm⁻³. The barrier layer may have a stoichiometric composition in the range of C₁H_{0.59-0.80}.

### FIELD OF THE INVENTION

This invention relates to a barrier layer.

### BACKGROUND OF THE INVENTION

Plastic containers are disadvantageously not impermeable to certain gases, such as oxygen and carbon dioxide.

The shelf life of a carbonated drink may thus be limited by the gradual migration of its carbon dioxide through the plastic container. In addition, the shelf life of any liquid contained in a plastic container may be limited by oxygen in the surrounding atmosphere penetrating the plastic container and coming into contact with the liquid, placing the liquid at risk of oxidation accompanied by a deterioration in its organoleptic properties.

An approach for improving the shelf life of a liquid contained in a container has been to enhance the natural barrier effect of the substance used to make the plastic container by lining a wall of the container with a barrier layer, i.e., a layer of material which has a stronger barrier effect than the substance used to make the plastic container. A need still exists, however, for barrier layers having improved barrier characteristics.

### SUMMARY OF THE INVENTION

In one aspect, the invention features a plastic container coated with a barrier layer on an inner surface thereof and a process for coating an inner surface of a plastic container with a barrier layer. The barrier layer consists essentially of carbon and hydrogen. The barrier layer has a hydrogen concentration ([H]/([C]+[H])) of from about 37% to about 45%. The barrier layer has a sp²/sp³ carbon ratio of from about 0.2 to about 0.3. The barrier layer has an optical gap E₀₄ of from about 2.3 eV to about 2.9 eV. The barrier layer has a spin density of from about 6×10¹⁸ cm⁻³ to about 2×10²⁰ cm⁻³. The barrier layer has a stoichiometric composition in the range of C₁H_{0.59-0.80}.

The inner surface of the plastic container is coated with the barrier layer by a process including placing the plastic container in a treatment chamber containing a reaction zone located inside the plastic container. The process also includes lowering a pressure inside the treatment chamber but outside the reaction zone to a range of from 3×10³ Pa to 6×10³ Pa. The process additionally includes lowering a pressure inside the reaction zone to a range of from 3.5 Pa to 8 Pa. The process further includes injecting a reactive fluid into the reaction zone at a flow rate of from 50 sccm to 300 sccm for a period (T1) of from 0.2 second to 2.52 seconds prior to subjecting the reactive fluid to electromagnetic radiation. The process still further includes continuing to inject the reactive fluid into the reaction zone while the reactive fluid is subjected to electromagnetic radiation in the reaction zone for a period (T2) of from 0.5 second to 3 seconds thereby depositing the barrier layer on the inner surface of the plastic container. The process also includes removing the coated plastic container from the treatment chamber.

In another aspect, the invention features a plastic container coated with a barrier layer on an inner surface thereof and having an increased oxygen transmission rate (OTR) barrier improvement factor (BIF) and a process for increasing an OTR BIF of a plastic container by coating an inner surface of the container with a barrier layer. The barrier layer consists essentially of carbon and hydrogen and has a stoichiometric composition in the range of C₁H_{0.59-0.80}. Plastic containers coated with a barrier layer having an average thickness of about 30 nm to about 60 nm may have an OTR BIF of at least 20. Plastic containers coated with a barrier layer having an average thickness of about 120 nm to about 210 nm may have an OTR BIF of at least 65.

In still another aspect, the invention features a plastic container coated with a barrier layer on an inner surface thereof and having an increased BIF with respect to carbon dioxide (CO₂) and a process for increasing a BIF with respect to CO₂ of a plastic container by coating an inner surface of the container with a barrier layer. The barrier layer consists essentially of carbon and hydrogen and has a stoichiometric composition in the range of C₁H_{0.59-0.80}. Plastic containers coated with a barrier layer having an average thickness of about 30 nm to about 60 nm may have a BIF with respect to CO₂ of at least 6. Plastic containers coated with a barrier layer having an average thickness of about 120 nm to about 210 nm may have a BIF with respect to CO₂ of at least 17.

In yet another aspect, the invention features a 28 g, 500 mL polyethylene terephthalate (PET) container coated with a barrier layer on an inner surface thereof and a process for coating an inner surface of a 28 g, 500 mL PET container with a barrier layer. The barrier layer consists essentially of carbon and hydrogen and has a stoichiometric composition in the range of C₁H_{0.59-0.80}. 28 g, 500 mL PET containers coated with a barrier layer having an average thickness of about 30 nm to about 60 nm may have an OTR of 0.001 cc/container/24 h or less. 28 g, 500 mL PET containers coated with a barrier layer having an average thickness of about 120 nm to about 210 nm may have an OTR of 0.0005 cc/container/24 h or less.

In an additional aspect, the invention features a 22 g, 330 mL PET container coated with a barrier layer on an inner surface thereof and a process for coating an inner surface of a 22 g, 330 mL PET container with a barrier layer. The barrier layer consists essentially of carbon and hydrogen and has a stoichiometric composition in the range of C₁H_{0.59-0.80}. 22 g, 330 mL PET containers coated with a barrier layer having an average thickness of about 120 nm to about 210 nm may have an OTR of 0.0005 cc/container/24 h or less.

One or more of the following features may also be included.

The barrier layer may have an average thickness of from 30 nm to 210 nm. The plastic container may be made of PET. The electromagnetic radiation may include microwaves output at a power of from 100 W to 850 W. The pressure inside the reaction zone may be lowered to a range of from 4 Pa to 6 Pa. The reactive fluid may be injected into the reaction zone at a flow rate of from 100 sccm to 180 sccm for a period (T1) of from 1.0 second to 1.5 seconds prior to subjecting the reactive fluid to electromagnetic radiation. The reactive fluid may continue to be injected into the reaction zone while the reactive fluid is subjected to electromagnetic radiation in the reaction zone for a period (T2) of from 1.0 second to 2.5 seconds thereby depositing the barrier layer on the inner surface of the plastic container. The process may coat the inner surfaces of at least 10,000 plastic containers per hour. The total of T1+T2 may be 3.5 seconds or less.

Embodiments may have one or more of the following advantages.

Plastic containers coated with the barrier layers on inner surfaces thereof may have superior impermeability to certain gases, such as oxygen and carbon dioxide. For example, plastic containers coated with the barrier layers on inner surfaces thereof may achieve OTR BIFs and/or BIFs with respect to CO₂ that have, until now, never been achieved. Particular embodiments of the processes for coating inner surfaces of plastic containers with the barrier layers may yield coated containers having particularly advantageous impermeability properties.

Further aspects, features and advantages will become apparent from the following.

### BRIEF DESCRIPTION OF THE DRAWINGS

FIG. 1 is a graph showing the visible Raman spectra for both an uncoated polyethylene terephthalate (PET) bottle (the blank) and a barrier layer-coated PET bottle.

FIG. 2 are graphs showing the difference in visible Raman spectra (514 nm) of a barrier layer coating.

FIG. 3 is a diagrammatic view illustrating an apparatus for coating an inner surface of a plastic container with a barrier layer.

### DETAILED DESCRIPTION OF THE INVENTION

The barrier layer to be coated on an inner surface of a plastic container may consist essentially of carbon and hydrogen. Thus, in addition to carbon and hydrogen, the barrier layer may include minor amounts of any other component which does not materially affect the basic and novel characteristics of the barrier layer as described herein.

The barrier layer may have a hydrogen concentration ([H]/([C]+[H])) of from about 37% to about 45%. The values of [C] and [H] needed to determine the hydrogen concentration may be determined through Rutherford backscattering (RBS) and Elastic Recoil Detection Analysis (ERDA), respectively, using methods known in the art. For both RBS and ERDA, samples may be covered with a 15 nm thin graphite layer. The metallic nature of the graphite layer may avoid a buildup of electric charge under the measurements.

For RBS measurements, a sample barrier layer may be bombarded with ⁴He ions of a kinetic energy of 1 MeV or 2 MeV. The measurements may be done under high vacuum conditions and at room temperature. The backscattering angle may be chosen to be 165° in the IBM geometry, and the particles may be collected in a solid angle of 2.5°. The total collected charge for each spectrum may be 4 μC.

For ERDA measurements, a sample barrier layer may be bombarded with 2 MeV ⁴He ions. The detection of the forward scatted He ions may be done at an angle of 30° from the layer plane. Forward scattered ⁴He ions may be filtered by a thin mylar film placed before the particle detector. The total collected charge may be 1 μC.

As used with respect to the hydrogen concentration ranges and anywhere else herein, the term “about” reflects the fact that the specific lower or upper limit of a range is not intended to be an absolute value. The outer range covered by the term “about” could be readily determined by one of ordinary skill in the art given the objectives of the invention and embodiments described herein, but in general can be said to encompass variations of up to several percent of the value of each range endpoint.

The barrier layer may have a sp²/sp³ carbon ratio of from about 0.2 to about 0.3. The sp²/sp³ carbon ratio may be determined through Raman measurements, using a method known in the art. Raman measurements may be carried out on a Renishaw system at laser wavelengths of 514 cm⁻¹ (visible) and of 229 cm⁻¹ (UV). Spectra may be taken on a sample container coated with three times the desired thickness (triple thickness) of the barrier layer. A comparison spectra is taken for an uncoated container (blank). The barrier layer component of the spectra may be extracted by difference.

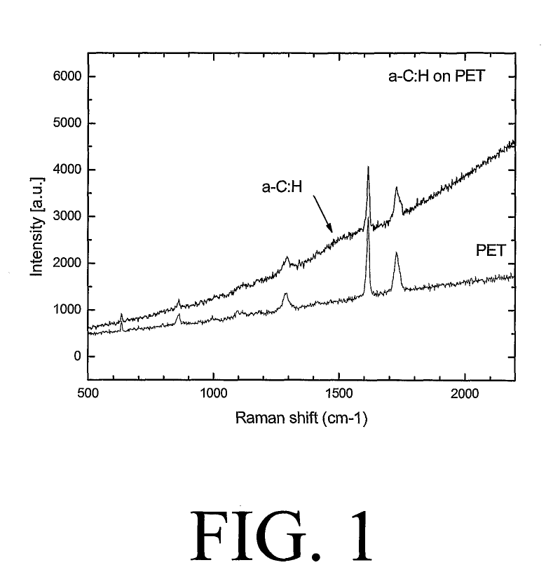

Referring to FIG. 1, it shows the visible Raman spectra for both an uncoated polyethylene terephthalate (PET) bottle (the blank) and a barrier layer-coated PET bottle. The blank spectrum consists of sharp peaks. The barrier layer component is the small noisy hump to the left of the PET peaks, indicated by an arrow. The PET spectrum has a “luminescence” background which rises toward the right. The background is much more intense in the barrier layer spectrum.

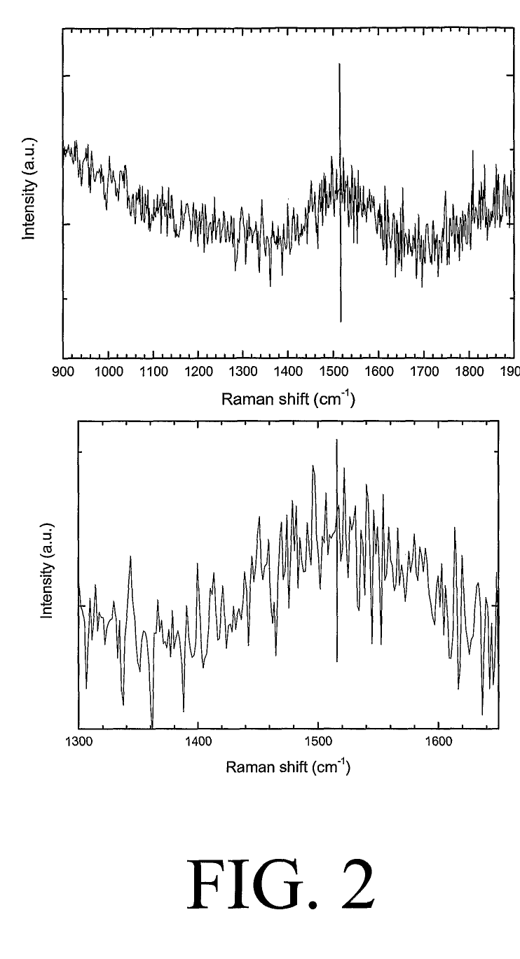

Referring to FIG. 2, it shows the extracted spectra for the barrier layer. It shows the G peak, which lies here at 1518 cm⁻¹. Its full width half maximum (FWHM) is 145 cm⁻¹. The spectra do not show evidence of a D peak, which can appear at 1,350 cm⁻¹. The spectra has been corrected for the PET background and normalized to the PET peak at ˜1730 cm⁻¹. The lower trace is an expansion of G peak region at 1518 cm-⁻¹.

The barrier layer may have an optical gap E₀₄ of from about 2.3 eV to about 2.9 eV. The optical gap E₀₄ for a barrier layer may be determined in the spectral range going from 1 eV to 3.5 eV by a combination of transmittance and reflectance spectroscopy using a Cary 5E spectrophotometer. The analysis of the spectra may be performed with a commercial FilmWizard programme using different dispersion models.

The barrier layer may have a spin density of from about 6×10¹⁸ cm⁻³ to about 2×10²⁰ cm⁻³. The spin density of the barrier layer may be determined by EPR (Electron Paramagnetic Resonance) measurements performed with an X-band spectrometer at room temperature, as is known in the art. Typical experimental conditions may be used, such as a microwave frequency of 9.6 GHz, a microwave power of 1 mW, and a magnetic field modulation at 100 kHz. The microwave frequency may be measured with a frequency meter for each spectrum, and the g-values of the isotropic spectra may be determined to Δg=±0.0002. The lineshape may be determined by a comparison with Lorentzian and Gaussian lineshapes. The spin density may be obtained by a direct double integration of the experimental spectrum and a comparison with a calibrated ruby sample.

The barrier layer may have a stoichiometric composition in the range of C₁H_{0.59-0.80}. The stoichiometric composition of the barrier layer may be determined knowing [H] and [C]. For example, for a measured [C] of 0.89×10²³ atom/cm³, and a measured [H] range of from 0.53 to 0.71×10²³ atom/cm³, [C]/[C]=0.89×10²³ (atom/cm³)/0.89×10²³ (atom/cm³)=1, and [H]/[C]=0.53 to 0.71×10²³ (atom/cm³)/0.89×10²³ (atom/cm³)=0.59 to 0.80.

The barrier layer may contain not only the CH and CH₂ bonds found in hard carbon, but also CH₃ bonds, which are absent in hard carbon. For example, the proportion of CH₃, CH₂ and CH bonds may be 0, 40, and 60, respectively, in hard carbon. The barrier layer, on the other hand, may contain a proportion of CH₃, CH₂ and CH bonds of, for example, 0.20, 0.73, and 0.06, respectively. The proportion of CH₃, CH₂ and CH bonds in the barrier layer may be determined by examining the infra-red (IR) vibration spectra of the barrier layer, as explained in, for example, J. ROBERTSON, Mat Sci Eng R 37, 129-281 (2002), which is hereby incorporated by reference in its entirety.

The barrier layer may be coated onto any plastic container. Preferably, the barrier layer may be coated onto an inner surface of a container made of a composition containing polyethylene terephthalate (PET), and more preferably a PET container.

The barrier layer may be coated onto a plastic container at any desired average thickness. Preferably, the barrier layer may be coated onto an inner surface of a plastic container at an average thickness which is not too high, so as not to impart a mechanical rigidity to the barrier layer which may cause the barrier layer to become unstuck from the plastic container or which may cause the plastic container to rupture. For example, the barrier layer preferably may be coated onto an inner surface of a plastic container at an average thickness of from 30 nm to 210 nm, more preferably from 45 nm to 110 nm.

Particularly preferred average thickness ranges for the barrier layer may correspond with certain end-use applications. For example, a plastic container which may be intended to store a carbonated beverage, such as a soft drink or water, or an oxygen-sensitive beverage, such as tea or juice, preferably may have the barrier layer coated on an inner surface thereof at an average thickness of from about 30 nm to about 60 nm. On the other hand, a plastic container which may be intended to store beer preferably may have the barrier layer coated on an inner surface thereof at an average thickness of from about 120 nm to about 210 nm.

The specific ranges of from about 30 nm to about 60 nm and from about 120 nm to about 210 nm are only preferred ranges for the particular end-use applications noted. Plastic containers intended to store a carbonated beverage, such as a soft drink or water, or an oxygen-sensitive beverage, such as tea or juice, may have the barrier layer coated on an inner surface thereof at an average thickness outside the range of from about 30 nm to about 60 nm. Likewise, plastic containers intended to store beer may have the barrier layer coated on an inner surface thereof at an average thickness outside the range of from about 120 nm to about 210 nm.

The average thickness of a barrier layer coated on an inner surface of a plastic container may be determined by measuring the thickness of the barrier layer at different areas of the container. The different areas of the container may be identified and prepared for measurement on, for example, a Dektak III Profilometer (available from SNF at Stanford University, UK) according to the following example procedure described with respect to embodiments wherein the plastic container is a bottle.

About six to twelve different areas, or reference points, for measurement may be identified. For example, two to four areas on the neck of the uncoated bottle; two to four areas on the body of the uncoated bottle; and two to four areas on the foot of the uncoated bottle. A simple marker may be used on the inside surface of the uncoated bottle to identify the eleven selected areas. The size of the marks may be around a few millimeters in diameter. The bottle then may be coated with the barrier layer. Samples having a dimension of, for example, one square inch (1 in²) next may be cut around the marked areas. The marks then may be removed using a solvent, such as, for example, acetone. A step may thereby be obtained between the barrier layer and the plastic container. Each sample then may be attached onto the samples holder of the profilometer for evaluation by the profilometer.

Plastic containers coated with the barrier layers on inner surfaces thereof may have superior impermeability to certain gases, such as oxygen and carbon dioxide, as reflected by their low OTRs and long shelf-lives with respect to CO₂ loss.

The OTR of a plastic container is a measure of the permeability of the container to oxygen from one side of the container to the other. It may be expressed in units of, for example, cc/container/24 h.

The OTR of a plastic container may be measured by using, for example, a MOCON Oxtran device (available from Mocon, Inc., Minneapolis, Minn.) to measure, on an empty container, oxygen penetration inside the container. Measurements may be made in a controlled environment at 22° C., 50% relative humidity, and atmospheric pressure.

For example, two bottles, glued and sealed on their necks, may be placed in measurement cells of the device. The two bottles may be placed in the same unit and measured in parallel. A mixture of nitrogen gas and hydrogen gas (95% N₂; 5% H₂) may be flushed inside both bottles at a flow of 10 ml/minute for sixteen (16) hours in order to remove all oxygen from inside the containers. At the end of the flush, oxygen cells are zeroed, and the bottles may be left alone for thirty (30) minutes without measuring. Thereafter, nitrogen flow may be diverted to an oxygen detector, and the oxygen content may be measured for the first bottle for thirty (30) minutes. At the end of the thirty (30) minutes, the second bottle may undergo the same procedure for thirty (30) minutes. For a total of 24 hours, the two bottles may be tested alternatively. After every five (5) measurements, the detection cell may be zeroed. Once the measurements are completed, they may be converted into oxygen migration, which may be expressed as cc/container/24 h. The values obtained may be converted according to the atmospheric pressure at the time of the evaluation.

The oxygen detector works on an electrochemical principal, whereby each oxygen molecule which reaches the detector generates an electron emission and an induced current that may be measured in a continuous manner during the measurement phases. The sensitivity of the MOCON Oxtran device may be 0.0003 cc/container/24 h, and its accuracy may be ±0.0005 cc/container/24 h.

The shelf-life with respect to CO₂ loss of a plastic container is a measure of the length of time (expressed in weeks) it may take for a beverage stored in the plastic container to lose a certain percentage of the CO₂ originally contained within the beverage. For a plastic container to be used for beer, the beverage industry has adopted a conventional target CO₂ loss of 10%. In other words, plastic containers to be used for storing beer may be evaluated for the length of time it takes for beer in the container to lose 10% of the total amount of CO₂ contained in the beer just before it was stored in the container. For a plastic container to be used for storing a carbonated soft drink, the beverage industry has adopted a conventional target CO₂ loss of 17.5%.

The shelf-life to either 10% or 17.5% CO₂ loss of a plastic container may be measured by the Zahm Nagel test method, as described in the International Society of Beverage Technologist's Voluntary Standard Test Methods for PET Bottles, Revision 1, October 2003, the entire disclosure of which is incorporated herein by reference.

The lower the OTR or the longer the shelf-life with respect to CO₂ loss of a plastic container, the more impermeable it is to the particular gas, and the better barrier function it provides. Plastic containers exhibiting an improved impermeability to gases, such as oxygen and CO₂, may advantageously extend the shelf life of a liquid contained in the container.

The OTR BIF and BIF with respect to CO₂ for a particular plastic container reflect the improvement in barrier function provided to the plastic container by the barrier layer coated on an inner surface of the container in comparison to the barrier function the same container would otherwise have if the container did not include the barrier layer. Specifically, the OTR BIF is the ratio of the OTR for an uncoated plastic container over the OTR for the same container coated with a barrier layer. The BIF with respect to CO₂ is the ratio of the shelf-life with respect to CO₂ loss for a coated plastic container over the shelf-life with respect to CO₂ loss for the same uncoated container.

Plastic containers coated with the barrier layers on inner surfaces thereof may advantageously achieve OTR BIFs and/or BIFs with respect to CO₂ that have, until now, never been achieved. For example, in preferred embodiments, a plastic container coated with a barrier layer which may have an average thickness of from about 30 nm to about 60 nm may possess an OTR BIF of at least 20 and a BIF with respect to CO₂ of at least 6. In other preferred embodiments, a plastic container coated with a barrier layer which may have an average thickness of from about 120 nm to about 210 nm may possess an OTR BIF of at least 65 and a BIF with respect to CO₂ of at least 17.

In particularly preferred embodiments, a 28 g, 500 mL PET container coated with a barrier layer which may have an average thickness of from about 30 nm to about 60 nm may possess an OTR of 0.001 cc/container/24 h. In other particularly preferred embodiments, a 28 g, 500 mL PET container coated with a barrier layer which may have an average thickness of from about 120 nm to about 210 nm may possess an OTR of 0.0005 cc/container/24 h or less. In still other particularly preferred embodiments, a 22 g, 330 mL PET container coated with a barrier layer which may have an average thickness of from about 120 nm to about 210 nm may possess an OTR of 0.0005 cc/container/24 h or less.

Plastic containers may be coated with the barrier layers by using a low-pressure plasma apparatus including a treatment chamber.

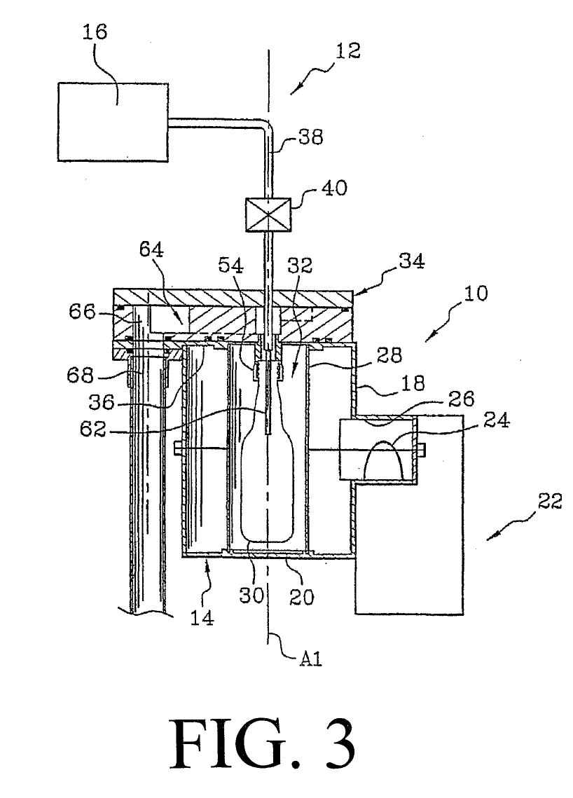

Illustrated in FIG. 3 is a diagrammatic view in axial cross section of a preferred embodiment of a treatment chamber 10. The treatment chamber 10 may, for example, make up part of a rotary machine which may include a carrousel driven in continuous rotational movement around a vertical axis.

The treatment chamber 10 may include an external enclosure 14 that may be made of an electrically conductive material such as metal, and which may be formed from a tubular cylindrical wall 18 with a vertical axis A1. The external enclosure 14 may be closed at its lower end by a bottom wall 20.

Outside the enclosure 14, there may be attached thereto a housing 22 that may include means (not shown) for creating inside the enclosure 14 an electromagnetic field capable of generating a plasma. Preferably, the means may be suitable for generating an electromagnetic radiation in the UHF range, that is, in the microwave range. For example, housing 22 may enclose a magnetron having an antenna 24 which may enter into a waveguide 26. For example, waveguide 26 may be a tunnel of rectangular cross-section that may extend along a radius of the axis A1 and may open directly into enclosure 14 through sidewall 18. Alternatively, there may be used a source of radio-frequency type radiation, and/or the source may be arranged differently, e.g., it may be arranged at the lower axial end of enclosure 14.

Inside enclosure 14, there may be a tube 28 with axis A1 which may be made of a material that may be transparent to the electromagnetic waves introduced into enclosure 14 via wave-guide 26. For example, tube 28 may be made of quartz. Tube 28 may receive a container 30 to be treated. An inside diameter of tube 28 may therefore be adapted to the diameter of the container. Tube 28 may also delimit a cavity 32 in which a partial vacuum may be created after the container is inside the enclosure.

As shown in FIG. 3, enclosure 14 may be partially closed at its upper end by an upper wall 36 that has a central opening of a diameter about equal to the diameter of tube 28, so that tube 28 may completely open upward to allow container 30 to be placed in cavity 32. As for lower metal wall 20, to which the lower end of tube 28 may be sealably attached, it may form the bottom of cavity 32.

To close enclosure 14 and cavity 32, treatment chamber 10 may have a cover 34 that may be axially movable between an upper position (not shown) and a lower closed position illustrated in FIG. 3. In the upper position, the cover may sufficiently open to allow container 30 to be introduced into cavity 32. In the closed position, shown in FIG. 3, cover 34 may rest sealably against the upper face of the upper wall 36 of the enclosure 14. Preferably, cover 34 does not function solely to sealably close cavity 32. Indeed, it may have additional parts.

Cover 34 may have means to support container 30. For example, container 30 may be a bottle having a small collar that may extend radially out from the base of the neck in such a way that it may be grasped by a gripper cup 54 that may engage or snap around the neck, preferably under the collar. Once it is picked up by gripper cup 54, container 30 may be pressed upward against the support surface of gripper cup 54. Preferably, the support surface may be impermeable so that when cover 34 is in the closed position, the interior space of cavity 32 may be separated by the wall of container 30 into two parts: the interior of container 30 (i.e., the reaction zone of treatment chamber 10) and the exterior of container 30.

An inner surface of container 30 may be treated by controlling both the pressure and the composition of the gases present inside the container. For example, the interior of container 30 may be connected with a vacuum source and with a reactive fluid feed device 12. Fluid feed device 12 may include a source of reactive fluid 16 connected by a tube 38 to an injector 62 that may be arranged along axis A1 and which may be movable with reference to cover 34 between a retracted position (not shown) and a lowered position in which injector 62 may be inserted into container 30 through cover 34. Control valve 40 may be interposed in tube 38 between fluid source 16 and injector 62.

Gas injected by injector 62 may be ionized and may form a plasma under the effect of the electromagnetic field created in the enclosure by lowering the pressure in container 30 to less than the atmospheric pressure. The reaction zone of treatment chamber 10, i.e., the interior of container 30, may be connected to a vacuum source, e.g., a pump, by including in cover 34 an internal channel 64 having a main termination which opens into the inner face of cover 34. For example, if container 30 is a bottle, internal channel 64 may have a main termination which opens at the center of the support surface against which the neck of the bottle may be pressed.

Preferably, the support surface is not formed directly on the lower face of cover 34, but rather on a lower annular surface of gripper cup 54, which is attached beneath cover 34. Thus, when container 30 is a bottle, and the upper end of the neck of the bottle is pressed against the support surface, the opening of the bottle, which is delimited by this upper end, may completely enclose the orifice through which the main termination opens into the lower face of cover 34.

Internal channel 64 of cover 34 may include an interface end 66, and a vacuum system may include a fixed end 68 that is arranged so that both ends 66, 68 face each other when cover 34 is in the closed position.

The plastic containers which may receive a barrier layer on an inner surface thereof may be relatively deformable. For example, the plastic containers may be unable to withstand an overpressure on the order of 10⁵ Pa between the outside and the inside of the container. Thus, the part of cavity 32 outside the container, i.e., outside the reaction zone, may be at least partially depressurized. Also, internal channel 64 of cover 34 may include, in addition to the main termination, an auxiliary termination (not shown) that may also open through the lower face of cover 34, but radially outside the annular support surface against which a part of container 30, such as the neck of container 30 when container 30 is a bottle, may be pressed. Thus, the same pumping means may simultaneously create a vacuum inside and outside container 30, i.e., inside and outside the reaction zone. Cover 34 may be provided with a control valve (not shown) that may close off the auxiliary termination.

Treatment chamber 10 may be operated as follows in order to provide some of the preferred embodiments of containers coated on an inner surface with a barrier layer.

A container may be loaded onto gripper cup 54, and cover 34 may be lowered into its closed position. Injector 62 may be lowered through the main termination of channel 64 without blocking it.

Cavity 32 may be connected to a vacuum system by internal channel 64 of cover 34. Thus, when cover 34 is in the closed position, air contained in cavity 32 may be exhausted.

At first, valve 40 may be open so that the pressure drops in cavity 32 both inside and outside container 30, i.e., both inside the reaction zone and outside the reaction zone. When the vacuum level outside the container has reached the desired level, valve 40 may be closed. Pumping may then continue exclusively inside container 30. When the desired treatment pressure in the reaction zone is reached, treatment within the reaction zone may begin.

Preferably, the pressure inside the treatment chamber but outside the reaction zone, i.e., the pressure within cavity 32 but outside container 30, may be lowered to a range of from 3×10³ Pa to 6×10³ Pa. Preferably, pumping may then be continued exclusively within the reaction zone, i.e., within container 30, until the pressure inside the reaction zone may be lowered to a range of from 3.5 Pa to 8 Pa, more preferably, to a range of from 4 Pa to 6 Pa.

Beginning at a time T0 when the desired treatment pressure is reached in the reaction zone, that is, inside container 30, valve 40 may be opened for a reactive fluid to be injected into the reaction zone. Then, beginning at a time T1, an electromagnetic field may be applied in the reaction zone. Preferably, time T1 may be from 0.2 second to 2.52 seconds after T0. Thus, a reactive fluid may be injected into the reaction zone for a period of time represented by T1 ranging from 0.2 second to 2.52 seconds prior to subjecting the reactive fluid to electromagnetic radiation. More preferably, time T1 may be from 1.0 second to 1.5 seconds after T0.

The reactive fluid may continue to be injected into the reaction zone while the reactive fluid is subjected to electromagnetic radiation in the reaction zone up to a time T2, thereby depositing the barrier layer on the inner surface of the plastic container. Preferably, time T2 may be from 0.5 second to 3 seconds after T1. More preferably, time T2 may be from 1.0 second to 2.5 seconds after T1.

Preferably, the reactive fluid may be selected from the group consisting of an alkane (for example methane), an alkene, an alkyne (for example acetylene) and an aromatic compound. More preferably, the reactive fluid may be an alkane such as methane or an alkyne such as acetylene. Most preferably, the reactive fluid may be acetylene.

Preferably, the reactive fluid may be injected into container 30 at a flow rate of from 50 sccm to 300 sccm (standard cubic centimeters per minute), and more preferably at a flow rate of from 100 to 180 sccm.

Preferably, the electromagnetic radiation may be microwaves output at a power of from 100 W to 850 W, and more preferably at a power of from 200 W to 400 W.

Preferably, the process for coating an inner surface of a plastic container with a barrier layer coats the inner surfaces of at least 10,000 plastic containers per hour.

Treatment chamber 10 may be further operated as follows in order to provide some of the more particularly preferred embodiments of containers coated on an inner surface with a barrier layer.

A preferred process for producing a plastic container coated on an inner surface thereof with a barrier layer having an average thickness of about 30 nm to about 60 nm includes: lowering the pressure inside the reaction zone to a range of from 4 Pa to 8 Pa; injecting the reactive fluid into the reaction zone at a flow rate of from 100 sccm to 120 sccm for a period (T1) of from 0.2 second to 2.52 seconds; and continuing to inject the reactive fluid into the reaction zone while the reactive fluid is subjected to microwave radiation at a power of from 200 W to 400 W in the reaction zone for a period (T2) of from 0.5 second to 1.5 seconds.

A preferred process for producing a plastic container coated on an inner surface thereof with a barrier layer having an average thickness of about 120 nm to about 210 nm includes: lowering the pressure inside the reaction zone to a range of from 4 Pa to 8 Pa; injecting the reactive fluid into the reaction zone at a flow rate of from 140 sccm to 160 sccm for a period (T1) of from 0.2 second to 1.2 seconds; and continuing to inject the reactive fluid into the reaction zone while the reactive fluid is subjected to microwave radiation at a power of from 300 W to 380 W in the reaction zone for a period (T2) of from 2.5 second to 3.0 seconds.

A preferred process for increasing an OTR BIF or a BIF with respect to CO₂ of a plastic container by coating an inner surface of the container with a barrier layer having an average thickness of about 30 nm to about 60 nm includes: lowering the pressure inside the reaction zone to a range of from 3.5 Pa to 6 Pa; injecting the reactive fluid into the reaction zone at a flow rate of from 100 sccm to 120 sccm for a period (T1) of from 0.2 second to 1.2 seconds; and continuing to inject the reactive fluid into the reaction zone while the reactive fluid is subjected to microwave radiation at a power of from 200 W to 400 W in the reaction zone for a period (T2) of from 0.5 second to 1.5 seconds. The OTR BIF of a plastic container coated by the preferred process may be, for example, at least 20, and the BIF with respect to CO₂ of a plastic container coated by the preferred process may be, for example, at least 6.

A preferred process for increasing an OTR BIF or a BIF with respect to CO₂ of a plastic container by coating an inner surface of the container with a barrier layer having an average thickness of about 120 nm to about 210 nm includes: lowering the pressure inside the reaction zone to a range of from 3.5 Pa to 6 Pa; injecting the reactive fluid into the reaction zone at a flow rate of from 140 sccm to 160 sccm for a period (T1) of from 0.2 second to 1.2 seconds; and continuing to inject the reactive fluid into the reaction zone while the reactive fluid is subjected to microwave radiation at a power of from 300 W to 380 W in the reaction zone for a period (T2) of from 2.5 second to 3.0 seconds. The OTR BIF of a plastic container coated by the preferred process may be, for example, at least 65, and the BIF with respect to CO₂ of a plastic container coated by the preferred process may be, for example, at least 17.

A preferred process for coating an inner surface of a 28 g, 500 mL PET container with a barrier layer having an average thickness of about 30 nm to about 60 nm includes: lowering the pressure inside the reaction zone to a range of from 3.5 Pa to 6 Pa; injecting the reactive fluid into the reaction zone at a flow rate of from 100 sccm to 120 sccm for a period (T1) of from 0.2 second to 1.2 seconds; and continuing to inject the reactive fluid into the reaction zone while the reactive fluid is subjected to microwave radiation at a power of from 200 W to 400 W in the reaction zone for a period (T2) of from 0.5 second to 1.5 seconds. The OTR of a plastic container coated by the preferred process may be, for example, 0.001 cc/container/24 h or less.

A preferred process for coating an inner surface of a 28 g, 500 mL PET container or a 22 g, 330 mL PET container with a barrier layer having an average thickness of about 120 nm to about 210 nm includes: lowering the pressure inside the reaction zone to a range of from 3.5 Pa to 6 Pa; injecting the reactive fluid into the reaction zone at a flow rate of from 140 sccm to 160 sccm for a period (T1) of from 0.2 second to 1.2 seconds; and continuing to inject the reactive fluid into the reaction zone while the reactive fluid is subjected to microwave radiation at a power of from 300 W to 380 W in the reaction zone for a period (T2) of from 2.5 second to 3.0 seconds. The OTR of a plastic container coated by the preferred process may be, for example, 0.0005 cc/container/24 h or less.

In certain particularly preferred embodiments of any of the above preferred processes, the process coats the inner surfaces of at least 12,000 plastic containers per hour, and the total of T1+T2 is 2.2 seconds or less. In other preferred embodiments, the process coats the inner surfaces of at least 10,000 plastic containers per hour, and the total of T1+T2 is 3.5 seconds or less.

The following specific examples further illustrate the invention.

### EXAMPLE 1

A 28 g, 500 mL polyethylene terephthalate (PET) bottle was placed in a treatment chamber. The pressure inside the treatment chamber but outside the reaction zone (i.e., outside the interior of the bottle) was lowered to 6×10³ Pa. The pressure inside the reaction (i.e., inside the bottle) was lowered to 5 Pa. Acetylene (C₂H₂) gas was injected into the reaction zone at a flow rate of 160 sccm for a period of time T1 equal to 1 second. Acetylene gas thereafter continued to be injected into the reaction zone while being subjected to microwaves output at a power of 350 W for a period of time T2 equal to 1 second, thereby depositing a barrier layer on the inner surface of the PET bottle. The coated PET bottle was removed from the treatment chamber.

Using the procedures described earlier herein, the barrier layer was determined to have: a hydrogen concentration of 44%, with a [C] of 0.89×10²³ at/cm³ and a [H] of 0.69×10²³ at/cm³; a sp²/sp³ carbon ratio of 0.25; an optical gap E₀₄ of 2.5 eV; a spin density of 2×10¹⁹ cm⁻³; and a stoichiometric composition of C₁H_{0.78}.

Ten separate reference points of the coated PET bottle were identified and measured for thickness by using a Dektak III Profilometer according to the procedure described earlier herein. From the data below, an average thickness of 60.1 nm was calculated for the 28 g, 500 mL coated PET bottle.

| Reference Point | Thickness (nm) |
|---|---|
| 1 | 48.3 |
| 2 | 55.8 |
| 3 | 61.9 |
| 4 | 57.3 |
| 5 | 71.3 |
| 6 | 60.6 |
| 7 | 59.2 |
| 8 | 67.2 |
| 9 | 61.2 |
| 10 | 58.3 |
| Average | 60.1 |

Using the MOCON Oxtran device and OTR measuring procedures described earlier herein, the barrier layer was determined to have an OTR of 0.0029 cc/container/24 h and an OTR BIF of 14.

### EXAMPLE 2

A barrier layer was coated on a 28 g, 500 mL PET bottle as described in Example 1, except that the time T2 equaled 1.4 seconds.

Ten separate reference points of the coated PET bottle were identified and measured for thickness by using a Dektak III Profilometer according to the procedure described earlier herein. From the data below, an average thickness of 85.9 nm was calculated for the 28 g, 500 mL coated PET bottle.

| Reference Point | Thickness (nm) |
|---|---|
| 1 | 81.8 |
| 2 | 97.9 |
| 3 | 86.6 |
| 4 | 71.5 |
| 5 | 104.7 |
| 6 | 91.3 |
| 7 | 94.8 |
| 8 | 92.6 |
| 9 | 71.2 |
| 10 | 66.8 |
| Average | 85.9 |

Using the MOCON Oxtran device and OTR measuring procedures described earlier herein, the barrier layer was determined to have an OTR of 0.0009 cc/container/24 h and an OTR BIF of 44.

### EXAMPLE 3

A barrier layer was coated on a 28 g, 500 mL PET bottle as described in Example 1, except that the time T2 equaled 2.9 seconds.

Using the procedures described earlier herein, the barrier layer was determined to have: a hydrogen concentration of 42%, with a [C] of 0.89×10²³ at/cm³ and a [H] of 0.66×10²³ at/cm³; a sp²/sp³ carbon ratio of 0.25; an optical gap E₀₄ of 2.5 eV; a spin density of 3×10¹⁹ cm⁻³; and a stoichiometric composition of C₁H_{0.75}.

Ten separate reference points of the coated PET bottle were identified and measured for thickness by using a Dektak III Profilometer according to the procedure described earlier herein. From the data below, an average thickness of 172.6 nm was calculated for the 28 g, 500 mL coated PET bottle.

| Reference Point | Thickness (nm) |
|---|---|
| 1 | 202.2 |
| 2 | 202.8 |
| 3 | 155.3 |
| 4 | 139.3 |
| 5 | 176.1 |
| 6 | 157.5 |
| 7 | 168.0 |
| 8 | 200.1 |
| 9 | 163.4 |
| 10 | 161.3 |
| Average | 172.6 |

Using the MOCON Oxtran device and QTR measuring procedures described earlier herein, the barrier layer was determined to have an OTR of 0.0006 cc/container/24 h and an OTR BIF of 66.

Using the Zahm Nagel test method described earlier herein, for an initial carbonation of 4.2 volumes, a Bericap polyvalent cap, and storage conditions of 21° C. at ambient relative humidity, the shelf-life to 17.5% CO₂ loss was calculated to be 53 weeks, yielding a BIF with respect to CO₂ of 5.3.

### EXAMPLE 4

A 26 g, 400 mL polyethylene terephthalate (PET) bottle was placed in a treatment chamber. The pressure inside the treatment chamber but outside the reaction zone (i.e., outside the interior of the bottle) was lowered to 4×10³ Pa. The pressure inside the reaction (i.e., inside the bottle) was lowered to 6 Pa. Acetylene (C₂H₂) gas was injected into the reaction zone at a flow rate of 100 sccm for a period of time T1 equal to 1.5 seconds. Acetylene gas thereafter continued to be injected into the reaction zone while being subjected to microwaves output at a power of 212 W for a period of time T2 equal to 1.2 seconds, thereby depositing a barrier layer on the inner surface of the PET bottle. The coated PET bottle was removed from the treatment chamber.

Six separate reference points of the coated PET bottle were identified and measured for thickness by using a Dektak III Profilometer according to the procedure described earlier herein. From the data below, an average thickness of 48.6 nm was calculated for the 26 g, 400 mL coated PET bottle.

| Reference Point | Thickness (nm) |
|---|---|
| 1 | 46.0 |
| 2 | 51.0 |
| 3 | 38.7 |
| 4 | 47.7 |
| 5 | 52.5 |
| 6 | 55.4 |
| Average | 48.6 |

Using the procedures described earlier herein, the barrier layer was determined to have: a hydrogen concentration of 44%, with a [C] of 0.89×10²³ at/cm³ and a [H] of 0.69×10²³ at/cm³; a sp²/sp³ carbon ratio of 0.25; an optical gap E₀₄ of 2.5 eV; a spin density of 2×10¹⁹ cm⁻³; and a stoichiometric composition of C₁H_{0.78}.

Using the MOCON Oxtran device and OTR measuring procedures described earlier herein, the barrier layer was determined to have an OTR of 0.0017 cc/container/24 h and an OTR BIF of 20.

Using the Zahm Nagel test method described earlier herein, for an initial carbonation of four (4) volumes, a Bericap polyvalent cap, and storage conditions of 23° C. at ambient relative humidity, the shelf-life to 17.5% CO₂ loss was calculated to be 24 weeks, yielding a BIF with respect to CO₂ of 4.

### EXAMPLE 5

A 31 g, 500 mL polyethylene terephthalate (PET) bottle was placed in a treatment chamber. The pressure inside the treatment chamber but outside the reaction zone (i.e., outside the interior of the bottle) was lowered to 5×10³ Pa. The pressure inside the reaction (i.e., inside the bottle) was lowered to 20 Pa. Acetylene (C₂H₂) gas was injected into the reaction zone at a flow rate of 132 sccm for a period of time T1 equal to 1 second. Acetylene gas thereafter continued to be injected into the reaction zone while being subjected to microwaves output at a power of 350 W for a period of time T2 equal to 2 seconds, thereby depositing a barrier layer on the inner surface of the PET bottle. The coated PET bottle was removed from the treatment chamber.

Using the MOCON Oxtran device and OTR measuring procedures described earlier herein, the barrier layer was determined to have an OTR of 0.0019 cc/container/24 h and an OTR BIF of 21.

Using the Zahm Nagel test method described earlier herein, for an initial carbonation of three (3) volumes, a Crown metallic cap, and storage conditions of 21° C. at ambient relative humidity, the shelf-life to 10% CO₂ loss was calculated to be 173 weeks, yielding a BIF with respect to CO₂ of 17.

### EXAMPLE 6

A 27 g, 500 mL polyethylene terephthalate (PET) bottle was placed in a treatment chamber. The pressure inside the treatment chamber but outside the reaction zone (i.e., outside the interior of the bottle) was lowered to 5×10³ Pa. The pressure inside the reaction (i.e., inside the bottle) was lowered to 6 Pa. Acetylene (C₂H₂) gas was injected into the reaction zone at a flow rate of 160 sccm for a period of time T1 equal to 1 second. Acetylene gas thereafter continued to be injected into the reaction zone while being subjected to microwaves output at a power of 380 W for a period of time T2 equal to 1.2 seconds, thereby depositing a barrier layer on the inner surface of the PET bottle. The coated PET bottle was removed from the treatment chamber.

Using the MOCON Oxtran device and OTR measuring procedures described earlier herein, the barrier layer was determined to have an OTR of 0.0036 cc/container/24 h and an OTR BIF of 11.

Using the Zahm Nagel test method described earlier herein, for an initial carbonation of 4.2 volumes, a Bericap polyvalent cap, and storage conditions of 21° C. at ambient relative humidity, the shelf-life to 17.5% CO₂ loss was calculated to be 46 weeks, yielding a BIF with respect to CO₂ of 4.6.

### EXAMPLE 7

A 28 g, 500 mL polyethylene terephthalate (PET) bottle was placed in a treatment chamber. The pressure inside the treatment chamber but outside the reaction zone (i.e., outside the interior of the bottle) was lowered to 5×10³ Pa. The pressure inside the reaction (i.e., inside the bottle) was lowered to 6 Pa. Acetylene (C₂H₂) gas was injected into the reaction zone at a flow rate of 160 sccm for a period of time T1 equal to 1.4 seconds. Acetylene gas thereafter continued to be injected into the reaction zone while being subjected to microwaves output at a power of 380 W for a period of time T2 equal to 2.3 seconds, thereby depositing a barrier layer on the inner surface of the PET bottle. The coated PET bottle was removed from the treatment chamber.

Using the MOCON Oxtran device and OTR measuring procedures described earlier herein, the barrier layer was determined to have an OTR of 0.0008 cc/container/24 h and an OTR BIF of 50.

Using the Zahm Nagel method described earlier herein, for an initial carbonation of 4.4 volumes, a Monobloc standard cap, and storage conditions of 23° C. at ambient relative humidity, the shelf-life to 17.5% CO₂ loss was calculated to be 100 weeks, yielding a BIF with respect to CO₂ of 5.5.

Further embodiments are within the following claims.

What is claimed is:

1. A plastic container coated with a barrier layer on an inner surface thereof, the barrier layer consisting essentially of carbon and hydrogen and having:
a hydrogen concentration ([H]/([C]+[H])) of from about 37% to about 45%;
a sp²/sp³ carbon ratio of from about 0.2 to about 0.3;
an optical gap E₀₄ of from about 2.3 eV to about 2.9 eV;
a spin density of from about 6×10¹⁸ cm⁻³ to about 2×10²⁰ cm⁻³; and
a stoichiometric composition in the range of C₁H_{0.59-0.80}.

2. The plastic container of claim 1, wherein the barrier layer has an average thickness of from 30 nm to 210 nm.

3. The plastic container of claim 1, wherein the barrier layer has an average thickness of from 45 nm to 110 nm.

4. The plastic container of claim 1, wherein the plastic container comprises polyethylene terephthalate (PET).

5. The plastic container of claim 1, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 8 Pa;
injecting a reactive fluid into the reaction zone at a flow rate of from 50 sccm to 300 sccm for a period (T1) of from 0.2 second to 2.52 seconds prior to subjecting the reactive fluid to electromagnetic radiation;
continuing to inject the reactive fluid into the reaction zone while the reactive fluid is subjected to electromagnetic radiation in the reaction zone for a period (T2) of from 0.5 second to 3 seconds thereby depositing the barrier layer on the inner surface of the plastic container; and
removing the coated plastic container from the treatment chamber.

6. The plastic container of claim 5, wherein the electromagnetic radiation comprises microwaves output at a power of from 100 W to 850 W.

7. The plastic container of claim 6, wherein the electromagnetic radiation comprises microwaves output at a power of from 200 W to 400 W.

8. The plastic container of claim 5, wherein the process coats the inner surfaces of at least 10,000 plastic containers per hour.

9. The plastic container of claim 1, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 4 Pa to 6Pa;
injecting a reactive fluid into the reaction zone at a flow rate of from 100 sccm to 180 sccm for a period (T1) of from 1.0 second to 1.5 seconds prior to subjecting the reactive fluid to electromagnetic radiation;
continuing to inject the reactive fluid into the reaction zone while the reactive fluid is subjected to electromagnetic radiation in the reaction zone for a period (T2) of from 1.0 second to 2.5 seconds thereby depositing the barrier layer on the inner surface of the plastic container; and
removing the coated plastic container from the treatment chamber.

10. A plastic container coated with a barrier layer on an inner surface thereof, the barrier layer having an average thickness of about 30 nm to about 60 nm, consisting essentially of carbon and hydrogen, and having:
a hydrogen concentration ([H]/([C]+[H])) of from about 37% to about 45%;
a sp²/sp³ carbon ratio of from about 0.2 to about 0.3;
an optical gap E₀₄ of from about 2.3 eV to about 2.9 eV;
a spin density of from about 6×10¹⁸ cm⁻³ to about 2×10²⁰ cm⁻³; and
a stoichiometric composition in the range of C₁H_{0.59-0.80}.

11. The plastic container of claim 10, wherein the plastic container comprises polyethylene terephthalate (PET).

12. The plastic container of claim 10, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 4 Pa to 8Pa;
injecting a reactive fluid into the reaction zone at a flow rate of from 100 sccm to 120 sccm for a period (T1) of from 0.2 second to 2.52 seconds prior to subjecting the reactive fluid to electromagnetic radiation;
continuing to inject the reactive fluid into the reaction zone while the reactive fluid is subjected to microwave radiation at a power of from 200 W to 400 W in the reaction zone for a period (T2) of from 0.5 second to 1.5 seconds thereby depositing the barrier layer on the inner surface of the plastic container; and
removing the coated plastic container from the treatment chamber.

13. The plastic container of claim 12, wherein the process coats the inner surfaces of at least 12,000 plastic containers per hour, and wherein the total of T1+T2 is 2.2 seconds or less.

14. The plastic container of claim 12, wherein the process coats the inner surfaces of at least 10,000 plastic containers per hour, and wherein the total of T1+T2 is 3.5 seconds or less.

15. A plastic container coated with a barrier layer on an inner surface thereof, the barrier layer having an average thickness of about 120 nm to about 210 nm, consisting essentially of carbon and hydrogen, and having:
a hydrogen concentration ([H]/([C]+[H])) of from about 37% to about 45%;
a sp²/sp³ carbon ratio of from about 0.2 to about 0.3;
an optical gap E₀₄ of from about 2.3 eV to about 2.9 eV;
a spin density of from about 6×10¹⁸ cm⁻³ to about 2×10²⁰ cm⁻³; and
a stoichiometric composition in the range of C₁H_{0.59-0.80}.

16. The plastic container of claim 15, wherein the plastic container comprises polyethylene terephthalate (PET).

17. The plastic container of claim 15, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 4 Pa to 8 Pa;
injecting a reactive fluid into the reaction zone at a flow rate of from 140 sccm to 160 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 300 W to 380 W in the reaction zone for a period (T2) of from 2.5 seconds to 3.0 seconds thereby depositing the barrier layer on the inner surface of the plastic container; and
removing the coated plastic container from the treatment chamber.

18. The plastic container of claim 17, wherein the process coats the inner surfaces of at least 10,000 plastic containers per hour, and wherein the total of T1+T2 is 3.5 seconds or less.

19. A plastic container coated with a barrier layer on an inner surface thereof, the barrier layer having an average thickness of about 30 nm to about 60 nm, consisting essentially of carbon and hydrogen, and having a stoichiometric composition in the range of C₁H_{0.59-0.80}, wherein an oxygen transmission rate (OTR) barrier improvement factor (BIF) of the coated plastic container is at least 20.

20. The plastic container of claim 19, wherein the plastic container comprises polyethylene terephthalate (PET).

21. The plastic container of claim 19, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 100 sccm to 120 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 200 W to 400 W in the reaction zone for a period (T2) of from 0.5 second to 1.5 seconds thereby depositing the barrier layer on the inner surface of the plastic container; and
removing the coated plastic container from the treatment chamber.

22. The plastic container of claim 21, wherein the process coats the inner surfaces of at least 12,000 plastic containers per hour, and wherein the total of T1+T2 is 2.2 seconds or less.

23. The plastic container of claim 21, wherein the process coats the inner surfaces of at least 10,000 plastic containers per hour, and wherein the total of T1+T2 is 3.5 seconds or less.

24. A plastic container coated with a barrier layer on an inner surface thereof, the barrier layer having an average thickness of about 120 nm to about 210 nm, consisting essentially of carbon and hydrogen, and having a stoichiometric composition in the range of C₁H_{0.59-0.80}, wherein an oxygen transmission rate (OTR) barrier improvement factor (BIF) of the coated plastic container is at least 65.

25. The plastic container of claim 24, wherein the plastic container comprises polyethylene terephthalate (PET).

26. The plastic container of claim 24, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 140 sccm to 160 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 300 W to 380 W in the reaction zone for a period (T2) of from 2.5 seconds to 3.0 seconds thereby depositing the barrier layer on the inner surface of the plastic container; and
removing the coated plastic container from the treatment chamber.

27. The plastic container of claim 26, wherein the process coats the inner surfaces of at least 10,000 plastic containers per hour, and wherein the total of T1+T2 is 3.5 seconds or less.

28. A plastic container coated with a barrier layer on an inner surface thereof, the barrier layer having an average thickness of about 30 nm to about 60 nm, consisting essentially of carbon and hydrogen, and having a stoichiometric composition in the range of C₁H_{0.59-0.80}, wherein a barrier improvement factor (BIF) with respect to carbon dioxide (CO₂) of the coated plastic container is at least 6.

29. The plastic container of claim 28, wherein the plastic container comprises polyethylene terephthalate (PET).

30. The plastic container of claim 28, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 100 sccm to 120 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 200 W to 400 W in the reaction zone for a period (T2) of from 0.5 second to 1.5 seconds thereby depositing the barrier layer on the inner surface of the plastic container; and
removing the coated plastic container from the treatment chamber.

31. The plastic container of claim 30, wherein the process coats the inner surfaces of at least 12,000 plastic containers per hour, and wherein the total of T1+T2 is 2.2 seconds or less.

32. The plastic container of claim 30, wherein the process coats the inner surfaces of at least 10,000 plastic containers per hour, and wherein the total of T1+T2 is 3.5 seconds or less.

33. A plastic container coated with a barrier layer on an inner surface thereof, the barrier layer having an average thickness of about 120 nm to about 210 nm, consisting essentially of carbon and hydrogen, and having a stoichiometric composition in the range of C₁H_{0.59-0.80}, wherein a barrier improvement factor (BIF) with respect to carbon dioxide (CO₂) of the coated plastic container is at least 17.

34. The plastic container of claim 33, wherein the plastic container comprises polyethylene terephthalate (PET).

35. The plastic container of claim 33, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 140 sccm to 160 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 300 W to 380 W in the reaction zone for a period (T2) of from 2.5 seconds to 3.0 seconds thereby depositing the barrier layer on the inner surface of the plastic container; and
removing the coated plastic container from the treatment chamber.

36. The plastic container of claim 35, wherein the process coats the inner surfaces of at least 10,000 plastic containers per hour, and wherein the total of T1+T2 is 3.5 seconds or less.

37. A 28 g, 500 mL polyethylene terephthalate (PET) container coated with a barrier layer on an inner surface thereof, the barrier layer having an average thickness of about 30 nm to about 60 nm, consisting essentially of carbon and hydrogen, and having a stoichiometric composition in the range of C₁H_{0.59-0.80}, wherein the coated plastic container has an oxygen transmission rate (OTR) of 0.001 cc/container/24 h or less.

38. The plastic container of claim 37, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 100 sccm to 120 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 200 W to 400 W in the reaction zone for a period (T2) of from 0.5 second to 1.5 seconds thereby depositing the barrier layer on the inner surface of the plastic container; and
removing the coated plastic container from the treatment chamber.

39. The plastic container of claim 38, wherein the process coats the inner surfaces of at least 12,000 plastic containers per hour, and wherein the total of T1+T2 is 2.2 seconds or less.

40. The plastic container of claim 38, wherein the process coats the inner surfaces of at least 10,000 plastic containers per hour, and wherein the total of T1+T2 is 3.5 seconds or less.

41. A 28 g, 500 mL polyethylene terephthalate (PET) container coated with a barrier layer on an inner surface thereof, the barrier layer having an average thickness of about 120 nm to about 210 nm, consisting essentially of carbon and hydrogen, and having a stoichiometric composition in the range of C₁H_{0.59-0.80}, wherein the coated plastic container has an oxygen transmission rate (OTR) of 0.0005 cc/container/24 h or less.

42. The plastic container of claim 41, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 140 sccm to 160 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 300 W to 380 W in the reaction zone for a period (T2) of from 2.5 seconds to 3.0 seconds thereby depositing the barrier layer on the inner surface of the plastic container; and
removing the coated plastic container from the treatment chamber.

43. The plastic container of claim 42, wherein the process coats the inner surfaces of at least 10,000 plastic containers per hour, and wherein the total of T1+T2 is 3.5 seconds or less.

44. A 22 g, 330 mL polyethylene terephthalate (PET) container coated with a barrier layer on an inner surface thereof, the barrier layer having an average thickness of about 120 nm to about 210 nm, consisting essentially of carbon and hydrogen, and having a stoichiometric composition in the range of C₁H_{0.59-0.80}, wherein the coated plastic container has an oxygen transmission rate (OTR) of 0.0005 cc/container/24 h or less.

45. The plastic container of claim 44, wherein the inner surface of the plastic container is coated with the barrier layer by a process comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 140 sccm to 160 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 300 W to 380 W in the reaction zone for a period (T2) of from 2.5 seconds to 3.0 seconds thereby depositing the barrier layer on the inner surface of the plastic container; and
removing the coated plastic container from the treatment chamber.

46. The plastic container of claim 45, wherein the process coats the inner surfaces of at least 10,000 plastic containers per hour, and wherein the total of T1+T2 is 3.5 seconds or less.

47. A process for coating an inner surface of a plastic container with a barrier layer, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 8 Pa;
injecting a reactive fluid into the reaction zone at a flow rate of from 50 sccm to 300 sccm for a period (T1) of from 0.2 second to 2.52 seconds prior to subjecting the reactive fluid to electromagnetic radiation;
continuing to inject the reactive fluid into the reaction zone while the reactive fluid is subjected to electromagnetic radiation in the reaction zone for a period (T2) of from 0.5 second to 3 seconds thereby depositing the barrier layer on the inner surface of the plastic container; and
removing the coated plastic container from the treatment chamber.

48. The process of claim 47, wherein the plastic container comprises polyethylene terephthalate (PET).

49. The process of claim 47, wherein the electromagnetic radiation comprises microwaves output at a power of from 100 W to 850 W.

50. The process of claim 49, wherein the electromagnetic radiation comprises microwaves output at a power of from 200 W to 400 W.

51. The process of claim 47, wherein the process coats the inner surfaces of at least 10,000 plastic containers per hour.

52. The process of claim 47, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 4 Pa to 6 Pa;
injecting a reactive fluid into the reaction zone at a flow rate of from 100 sccm to 180 sccm for a period (T1) of from 1.0 second to 1.5 seconds prior to subjecting the reactive fluid to electromagnetic radiation;
continuing to inject the reactive fluid into the reaction zone while the reactive fluid is subjected to electromagnetic radiation in the reaction zone for a period (T2) of from 1.0 second to 2.5 seconds thereby depositing the barrier layer on the inner surface of the plastic container; and
removing the coated plastic container from the treatment chamber.

53. A process for coating an inner surface of a plastic container with a barrier layer having an average thickness of about 30 nm to about 60 nm, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 4 Pa to 8 Pa;
injecting a reactive fluid into the reaction zone at a flow rate of from 100 sccm to 120 sccm for a period (T1) of from 0.2 second to 2.52 seconds prior to subjecting the reactive fluid to electromagnetic radiation;
continuing to inject the reactive fluid into the reaction zone while the reactive fluid is subjected to microwave radiation at a power of from 200 W to 400 W in the reaction zone for a period (T2) of from 0.5 second to 1.5 seconds thereby depositing the barrier layer on the inner surface of the plastic container; and
removing the coated plastic container from the treatment chamber.

54. The process of claim 53, wherein the plastic container comprises polyethylene terephthalate (PET).

55. The process of claim 53, wherein the process coats the inner surfaces of at least 12,000 plastic containers per hour, and wherein the total of T1+T2 is 2.2 seconds or less.

56. The process of claim 53, wherein the process coats the inner surfaces of at least 10,000 plastic containers per hour, and wherein the total of T1+T2 is 3.5 seconds or less.

57. A process for coating an inner surface of a plastic container with a barrier layer having an average thickness of about 120 nm to about 210 nm, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 4 Pa to 8 Pa;
injecting a reactive fluid into the reaction zone at a flow rate of from 140 sccm to 160 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 300 W to 380 W in the reaction zone for a period (T2) of from 2.5 seconds to 3.0 seconds thereby depositing the barrier layer on the inner surface of the plastic container; and
removing the coated plastic container from the treatment chamber.

58. The process of claim 57, wherein the plastic container comprises polyethylene terephthalate (PET).

59. The process of claim 57, wherein the process coats the inner surfaces of at least 10,000 plastic containers per hour, and wherein the total of T1+T2 is 3.5 seconds or less.

60. A process for increasing an oxygen transmission rate (OTR) barrier improvement factor (BIF) of a plastic container by coating an inner surface of the container with a barrier layer having an average thickness of about 30 nm to about 60 nm, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 100 sccm to 120 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 200 W to 400 W in the reaction zone for a period (T2) of from 0.5 second to 1.5 seconds thereby depositing the barrier layer on the inner surface of the plastic container; and
removing the coated plastic container from the treatment chamber;
wherein the oxygen transmission rate (OTR) barrier improvement factor (BIF) of the coated plastic container is at least 20.

61. The process of claim 60, wherein the plastic container comprises polyethylene terephthalate (PET).

62. The process of claim 60, wherein the process coats the inner surfaces of at least 12,000 plastic containers per hour, and wherein the total of T1+T2 is 2.2 seconds or less.

63. The process of claim 60, wherein the process coats the inner surfaces of at least 10,000 plastic containers per hour, and wherein the total of T1+T2 is 3.5 seconds or less.

64. A process for increasing an oxygen transmission rate (OTR) barrier improvement factor (BIF) of a plastic container by coating an inner surface of the container with a barrier layer having an average thickness of about 120 nm to about 210 nm, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 140 sccm to 160 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 300 W to 380 W in the reaction zone for a period (T2) of from 2.5 seconds to 3.0 seconds thereby depositing the barrier layer on the inner surface of the plastic container; and
removing the coated plastic container from the treatment chamber;
wherein the oxygen transmission rate (OTR) barrier improvement factor (BIF) of the coated plastic container is at least 65

65. The process of claim 64, wherein the plastic container comprises polyethylene terephthalate (PET).

66. The process of claim 64, wherein the process coats the inner surfaces of at least 10,000 plastic containers per hour, and wherein the total of T1+T2 is 3.5 seconds or less.

67. A process for increasing a barrier improvement factor (BIF) with respect to carbon dioxide (CO₂) of a plastic container by coating an inner surface of the container with a barrier layer having an average thickness of about 30 nm to about 60 nm, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 100 sccm to 120 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 200 W to 400 W in the reaction zone for a period (T2) of from 0.5 second to 1.5 seconds thereby depositing the barrier layer on the inner surface of the plastic container; and
removing the coated plastic container from the treatment chamber;
wherein the barrier improvement factor (BIF) with respect to carbon dioxide (CO₂) of the coated plastic container is at least 6.

68. The process of claim 67, wherein the plastic container comprises polyethylene terephthalate (PET).

69. The process of claim 67, wherein the process coats the inner surfaces of at least 12,000 plastic containers per hour, and wherein the total of T1+T2 is 2.2 seconds or less.

70. The process of claim 67, wherein the process coats the inner surfaces of at least 10,000 plastic containers per hour, and wherein the total of T1+T2 is 3.5 seconds or less.

71. A process for increasing a barrier improvement factor (BIF) with respect to carbon dioxide (CO₂) of a plastic container by coating an inner surface of the container with a barrier layer having an average thickness of about 120 nm to about 210 nm, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 140 sccm to 160 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 300 W to 380 W in the reaction zone for a period (T2) of from 2.5 seconds to 3.0 seconds thereby depositing the barrier layer on the inner surface of the plastic container; and
removing the coated plastic container from the treatment chamber;
wherein the barrier improvement factor (BIF) with respect to carbon dioxide (CO₂) of the coated plastic container is at least 17.

72. The process of claim 71, wherein the plastic container comprises polyethylene terephthalate (PET).

73. The process of claim 71, wherein the process coats the inner surfaces of at least 10,000 plastic containers per hour, and wherein the total of T1+T2 is 3.5 seconds or less.

74. A process for coating an inner surface of a 28 g, 500 mL polyethylene terephthalate (PET) container with a barrier layer having an average thickness of about 30 nm to about 60 nm, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 100 sccm to 120 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 200 W to 400 W in the reaction zone for a period (T2) of from 0.5 second to 1.5 seconds thereby depositing the barrier layer on the inner surface of the plastic container; and
removing the coated plastic container from the treatment chamber;
wherein the coated plastic container has an oxygen transmission rate (OTR) of 0.001 cc/container/24 h or less

75. The process of claim 74, wherein the process coats the inner surfaces of at least 12,000 plastic containers per hour, and wherein the total of T1+T2 is 2.2 seconds or less.

76. The plastic container of claim 74, wherein the process coats the inner surfaces of at least 10,000 plastic containers per hour, and wherein the total of T1+T2 is 3.5 seconds or less.

77. A process for coating an inner surface of a 28 g, 500 mL polyethylene terephthalate (PET) container with a barrier layer having an average thickness of about 120 nm to about 210 nm, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6 Pa;
injecting a reactive fluid into the reaction zone at a flow rate of from 140 sccm to 160 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 300 W to 380 W in the reaction zone for a period (T2) of from 2.5 seconds to 3.0 seconds thereby depositing the barrier layer on the inner surface of the plastic container; and
removing the coated plastic container from the treatment chamber;
wherein the coated plastic container has an oxygen transmission rate (OTR) of 0.0005 cc/container/24 h or less.

78. The process of claim 77, wherein the process coats the inner surfaces of at least 10,000 plastic containers per hour, and wherein the total of T1+T2 is 3.5 seconds or less.

79. A process for coating an inner surface of a 22 g, 330 mL polyethylene terephthalate (PET) container with a barrier layer having an average thickness of about 120 nm to about 210 nm, comprising:
placing the plastic container in a treatment chamber comprising a reaction zone located inside the plastic container;
lowering a pressure inside the treatment chamber but outside the reaction zone to a range of from 3×10³ Pa to 6×10³ Pa;
lowering a pressure inside the reaction zone to a range of from 3.5 Pa to 6Pa;
injecting a reactive fluid into the reaction zone at a flow rate of from 140 sccm to 160 sccm for a period (T1) of from 0.2 second to 1.2 seconds prior to subjecting the reactive fluid to electromagnetic radiation;
continuing to inject the reactive fluid into the reaction zone while the reactive fluid is subjected to microwave radiation at a power of from 300 W to 380 W in the reaction zone for a period (T2) of from 2.5 seconds to 3.0 seconds thereby depositing the barrier layer on the inner surface of the plastic container; and
removing the coated plastic container from the treatment chamber;
wherein the coated plastic container has an oxygen transmission rate (OTR) of 0.0005 cc/container/24 h or less.

80. The process of claim 79, wherein the process coats the inner surfaces of at least 10,000 plastic containers per hour, and wherein the total of T1+T2 is 3.5 seconds or less.
